(19) United States
(12) Patent Application Publication
(10) Pub. No.: US 2006/0085582 A1
(43) Pub. Date: Apr. 20, 2006

(54) Multiprocessor system

(75) Inventors: Hiroaki Shikano, Kokubunji (JP); Naohiko Irie, Kokubunji (JP)

Correspondence Address: Stanley P. Fisher;Reed Smith LLP, Suite 1400, 3110 Fairview Park Drive, Falls Church, VA, 22042, US

(73) Assignee: Hitachi, Ltd.

(21) Appl. No.: 11/203,284

(22) Filed: Aug. 15, 2005

(30) Foreign Application Priority Data
Oct. 20, 2004 (JP) 2004-305390

(51) Int. Cl. G06F 13/24

(52) U.S. Cl. 710/260

(57) ABSTRACT

An interrupt notification network is provided for a multiprocessor system in which many processor units are installed. An interrupt notification source processor unit transmits an interrupt notification packet to an interrupt notification destination processor unit. The interrupt notification packet to be transmitted by the interrupt notification source processor unit contains an interrupt destination process ID. A control section for the interrupt notification network analyzes the transmitted interrupt notification packet, references a table that defines the correspondence between internally retained IDs of processes and processor units that perform the processes, determines the interrupt notification destination processor unit, and transmits the interrupt notification packet to the processor unit. Consequently, the multiprocessor system in which many processor units are installed is capable of performing an inter-processor unit multiplex coordination process for inter-processor unit process synchronization and process control, increasing the system throughput, and providing increased real-time capability.

### CLAIM OF PRIORITY

The present application claims priority from Japanese application JP 2004-305390 filed on Oct. 20, 2004, the content of which is hereby incorporated by reference into this application.

### FIELD OF THE INVENTION

The present invention relates to a multiprocessor system, and more particularly to a multiprocessor system suitable for use in a system that comprises many processors and places emphasis on real-time response.

### BACKGROUND OF THE INVENTION

Devices are miniaturized due to the use of advanced semiconductor manufacturing technologies. Therefore, it is possible to integrate a huge number of transistors. At the same time, the frequencies of processors are increased. However, the operating power is increased. In addition, the standby power is also increased due to a leakage current. Therefore, the processor performance enhancement, which has been achieved by increasing the operating frequency and improving the logic method, is beginning to be limited. Under these circumstances, a multiprocessor system is now highlighted as promising means for improving the performance of and reducing the power consumption of an information processing apparatus. The multiprocessor system contains a plurality of CPUs, DSPs, or other conventional on-chip processor units (PUs) and performs parallel processing to deliver high computation performance without having to increase the operating frequency. It is predicted that the multiprocessor system will comprise 100 to 1000 on-chip PUs in the future due to the use of increasingly miniaturized circuits.

When the individual PUs are to operate in a coordinated manner within the multiprocessor system described above, it is necessary to furnish a scheme for ensuring that various items of interrupt information issued by the PUs and an external input/output device (IOD) are mutually exchanged. A method for communicating an interrupt request from an IOD to a PU via a common bus line within a conventional multiprocessor system is disclosed, for instance, by Japanese Patent Laid-Open No. 324570/1993 or Laid-Open No. 212472/1997. Further, a method for communicating an interrupt from one PU to another by furnishing the PUs with a plurality of signal lines, the number of which corresponds to the number of PUs, is disclosed by Japanese Patent Laid-Open No. 35694/1993.

At present, new applications are created to simultaneously handle images, voices, database information, and various other data within a car navigation system, cellular phone, digital television, or other apparatus. It is believed that the processor employed in such an apparatus incorporates various PUs in order to process various types of input data simultaneously by an optimum method. When a multiprocessor incorporating many such PUs is implemented, it is possible to simultaneously process various types of media information. As a result, it is conceivable that a system for recognizing the actual situation with high accuracy may be implemented. In a future multiprocessor system in which various data are simultaneously processed by many PUs, it is necessary to manage processes executed by the individual PUs, coordinate and synchronize the processes among a plurality of PUs, exercise low power control and other detailed PU control functions, and communicate an event from an external input/output device (IOD) to an arbitrary PU. To achieve the above purpose, it is necessary to furnish a scheme that exchanges various event information, that is, interrupt information, between the PUs or between a PU and IOD mutually and effectively without impairing the real-time capability.

The interrupt scheme of a conventional common processor, which comprises a single PU, will now be described with reference to FIG. 11.

FIG. 11 illustrates the configuration of a conventional common processor, which comprises a single PU.

As shown in FIG. 11, the conventional common processor, which comprises a single PU, includes a single interrupt controller (INTC) 303, which manages interrupt requests that are generated by a plurality of interrupt generation sources such as an I/O device (I/O) 301 and a memory transfer controller (DMAC) 302. The INTC checks interrupt requests that are received from interrupt generation sources, selects a request having the highest priority in compliance with a rule that is preestablished in a register within the INTC, and communicates the selected request to a CPU 300 via an interrupt signal line 304. Further, the INTC 303 sets an interrupt factor in an interrupt event register of the system. The CPU becomes aware of the interrupt factor when it accesses the interrupt event register. Consequently, an interrupt process is performed in accordance with a fixed relationship between interrupt factors and interrupt sources. Therefore, if, for instance, the interrupt process greatly varies with the interrupt factor or a plurality of interrupt actors simultaneously arise, a plurality of interrupt processes corresponding to the interrupt factor cannot be simultaneously handled.

To support PU-to-PU interrupts in a situation where the interrupt notification method for the conventional multiprocessor system is used, it is necessary to furnish PU-to-PU communication lines the number of which is equal to factorial (n−1)!, where n is the number of PUs. As a result, for a multiprocessor incorporating many PUs, the layout of the communication lines is very complicated and therefore impractical.

In addition, as the number of PUs is increased, it becomes difficult to determine the interrupt destination PU. To determine the interrupt destination PU, the interrupt source PU needs to know what process is being performed by the interrupt destination PU. To let the interrupt source determine the interrupt destination PU, therefore, the operating system (OS) needs, for instance, to access a process list that is managed in a particular memory area. Interrupt notification takes a certain amount of time due to the delay involved in memory access. As a result, the real-time capability is greatly impaired. To communicate an interrupt to a plurality of processes, which perform a particular processing operation in a coordinated manner within a process group, the interrupt source PU accesses the process list a number of times and communicates the interrupt to a plurality of associated PUs a number of times. Consequently, the system throughput and real-time response capability are significantly decreased as the number of PUs becomes large.

The present invention has been made to solve the above problem. It is an object of the present invention to furnish a multiprocessor system, in which many PUs are installed, with means for establishing effective interrupt communication between arbitrary PUs or between an IOD and PU with a view toward performing an inter-PU multiplex coordination process for inter-PU process synchronization and process control and increasing the system throughput of the multiprocessor system. It is another object of the present invention to provide a multiprocessor system that is capable of performing real-time processing in relation to various external factors, for instance, by immediately responding to an emergency.

### SUMMARY OF THE INVENTION

The multiprocessor system according to the present invention is provided with an interrupt notification network. The interrupt notification source processor unit or an input/output device transmits an interrupt notification packet to the interrupt notification destination processor unit.

The interrupt notification source processor unit transits the interrupt notification packet that contains an interrupt destination process ID. A control section of the interrupt notification network analyzes the interrupt notification packet that is transmitted from the interrupt notification source processor unit, determines the interrupt notification destination processor unit by referencing a relationship table that defines the relationship between internally retained process IDs and processor units that perform processes, and sends a transmission to the interrupt notification destination processor unit.

The interrupt notification packet may contain a flag for broadcasting, an interrupt level, and the information indicating the degree of emergency.

The input/output device at the interrupt notification source transmits the interrupt notification packet that contains an interrupt notification source input/output device number.

The control section of the interrupt notification network analyzes the interrupt notification packet that is transmitted from the input/output device at the interrupt notification source, determines the interrupt notification destination processor unit by referencing a relationship table that defines the relationship between internally retained input/output device numbers and interrupt destination processor units, and sends a transmission to the interrupt notification destination processor unit.

In the present invention, the table within the interrupt notification network retains the information for specifying the notification destination processor unit at the time of interrupt notification. Therefore, the processor unit that communicates an interrupt does not have to grasp the status of the notification destination processor unit and the status of the network that transmits the notification information at the time of interrupt issuance. Consequently, the interrupt notification process can be rapidly performed. Further, the control section of the interrupt notification network determines the interrupt notification destination processor unit and selectively transmits the interrupt information to the interrupt notification destination processor unit. Therefore, it is not necessary to install complicated signal lines between the processor units.

The interrupt notification packet contains a specified interrupt destination process ID. Therefore, the processor unit at the interrupt notification source does not have to know what processor unit is performing the interrupt notification destination process. As a result, interrupt issuance can be rapidly performed.

The present invention can also broadcast the interrupt information to a plurality of processor units within a specified range in accordance with the information set within the interrupt notification packet. Therefore, it is possible to perform a process for coordinating and controlling a plurality of processor units.

The present invention can also exercise interrupt control in accordance with predefined priority levels by making use of interrupt level and degree-of-emergency information set within the interrupt notification packet.

As described above, the present invention increases the system throughput of the multiprocessor system.

### BRIEF DESCRIPTION OF THE DRAWINGS

FIG. 1 is a block diagram that schematically illustrates the configuration of a multiprocessor system according to the present invention;

FIG. 2 is a block diagram that illustrates another configuration of a multiprocessor system according to the present invention;

FIG. 3 is a block diagram that illustrates a multiprocessor system according to the present invention and depicts the details of an interrupt notification network;

FIG. 4 is a block diagram that illustrates a multiprocessor system according to the present invention and depicts in detail the relationship between processors and processes;

FIG. 5 shows an example of a process-to-processor unit correspondence management table;

FIG. 6 shows an example of an interrupt notification packet;

FIG. 7 is a circuit diagram illustrating an interrupt notification network;

FIG. 8 is a first timing diagram illustrating an interrupt notification from one PU to another;

FIG. 9 is a second timing diagram illustrating an interrupt notification from one PU to another;

FIG. 10 is a timing diagram illustrating an interrupt notification from an I/O device to a PU; and

FIG. 11 illustrates the configuration of a conventional common processor that comprises a single PU.

### DETAILED DESCRIPTION OF THE PREFERRED EMBODIMENTS

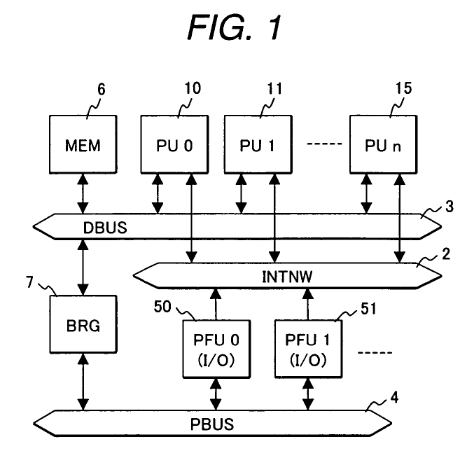

Embodiments of the present invention will now be described with reference to FIGS. 1 to 10.

[Multiprocessor System Configuration]

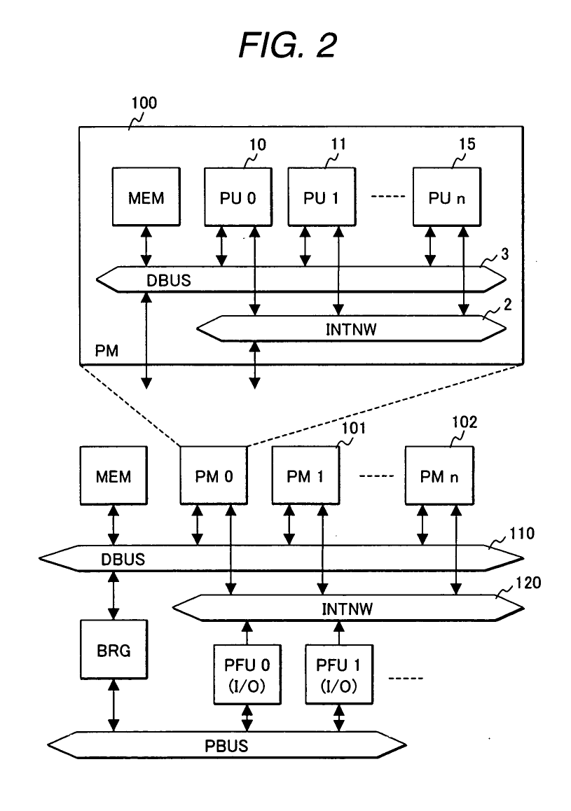

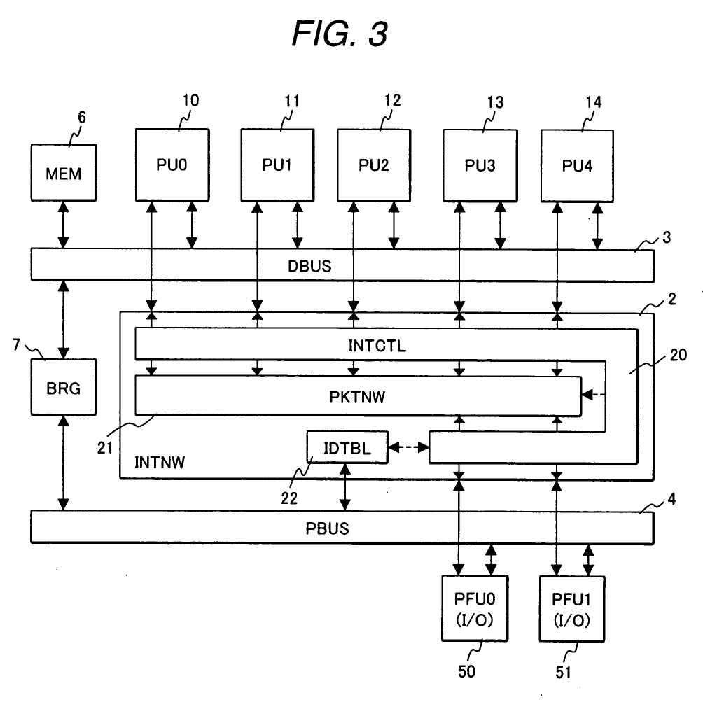

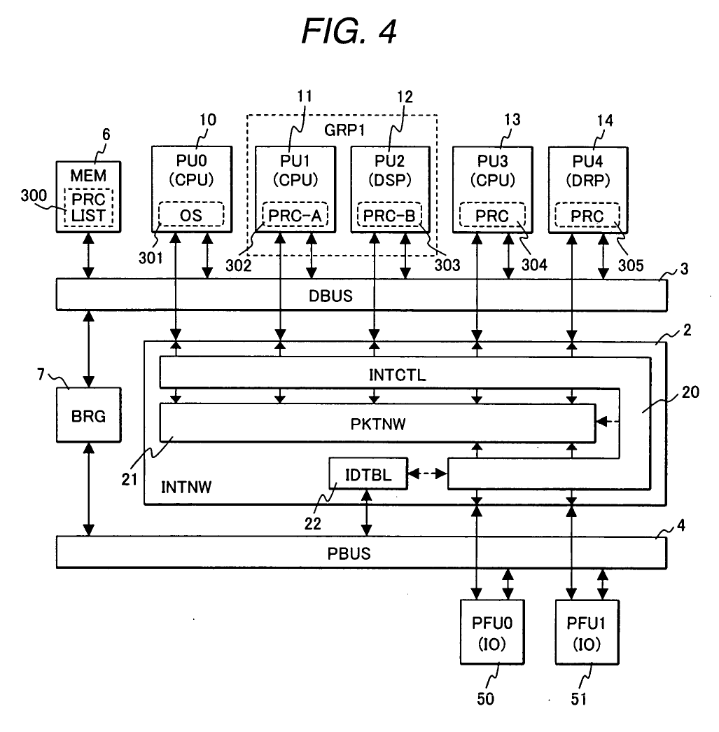

First of all, the configuration of a multiprocessor system according to the present invention will be described with reference to FIGS. 1 to 4. FIG. 1 is a block diagram that schematically illustrates the configuration of a multiprocessor system according to the present invention. FIG. 2 is a block diagram that illustrates another configuration of a multiprocessor system according to the present invention. FIG. 3 is a block diagram that illustrates a multiprocessor system according to the present invention and depicts the details of an interrupt notification network. FIG. 4 is a block diagram that illustrates a multiprocessor system according to the present invention and depicts in detail the relationship between processors and processes.

The multiprocessor system according to the present invention is a multiprocessor system in which a plurality of processor units (PUs) 11 to 15 communicate with each other for processing purposes as shown in FIG. 1.

The PUs can be configured variously, for instance, by combining general-purpose processors (CPUs), signal processors (DSPs), and dynamically reconfigurable processors (DRPs).

These PUs are interconnected via a data bus (DBUS) 3 and an interrupt network (INTNW) 2, which is peculiar to the present invention. A shared memory (MEM) 6, which can be accessed from the PUs, is connected to the DBUS 3. Peripheral function units (PFUs) 50, 51 for I/O devices (IODs), which are used to connect a display, keyboard, disk drive, and the like, are connected to a peripheral bus (PBUS) 4. The PBUS 4 and DBUS 3 are connected via a bridge (BRG) 7. Further, the PFUs 50, 51 are connected to the INTNW 2.

As shown in FIG. 2, a plurality of processor modules (PMs), which each comprise a plurality of PUs, may be arranged to form a hierarchical structure. The PMs 100 to 102 comprise the PUs 10 to 15 that are connected via the DBUS 3 and INTNW 2. Further, when the DBUS 3 and INTNW 2 within a PM are connected to an external DBUS 110 and an external INTNW 120, a PU within a certain PM can communicate an interrupt to a PU within another PM.

The configuration of the interrupt notification network (INTNW) 2 will now be described in detail with reference to FIG. 3.

The INTNW 2 has input/output ports, the number of which corresponds to the number of PUs and PFUs, and comprises an interrupt controller (INTCTL) 20, a packet network (PKTNW) 21, and a process-to-processor unit correspondence management table (IDTBL) 22.

The INTCTL 20 analyzes an interrupt packet that is issued by a PU or I/O device, and controls an interrupt packet flow in the INTNW 2. More specifically, when a PU or I/O device issues an interrupt packet, the INTCTL 20 analyzes the interrupt packet, references the IDTBL 22 to determine the interrupt destination PU, performs path setup by exercising switch control within the PKTNW 21, conducts output port connection rights arbitration, and exercises interrupt packet sequence control for real-time capability assurance. The INTCTL 20 can simultaneously control a plurality of switches within the PKTNW. The INTNW 2 can provide multicast notification, in which data is transferred with a plurality of output ports connected to a single input, in addition to unicast notification, in which data is transferred with a single output port connected to a single input. These operations will be described in detail later.

The PKTNW 21 is a network for interrupt packet transfer. An example having a crossbar structure will be described later.

The IDTBL 22 is a table that defines the relationship between processes and PUs/PFUs.

The relationship between processors and processes and the operations of the processors will now be described with reference to FIG. 4.

It is assumed that the multiprocessor system shown in FIG. 4 comprises five PUs (CPUs, DSP, and DRP) 10 to 14 and two PFUs (I/O devices) 50, 51. The PUs 10 to 14 are connected to the DBUS 3 and INTNW 2. The I/O devices 50, 51 are connected to the PBUS 4 and INTNW 2. The PBUS 4 is connected to the DBUS 3 via the BRG 7.

The PUs 10 to 14 perform various processes (PRCs) 301 to 305. For the sake of brevity, however, it is assumed that each PU performs only one process. PU0 10 executes an operating system (OS) 301, which manages the processes (tasks) of the entire system. The OS places a process list (PRCLIST) 300 in the MEM 6. The process list is a list of processes that the OS manages.

First of all, the interrupt operation performed by the multiprocessor system according to the present invention will be outlined.

When an interrupt notification is to be sent from one PU to another, the interrupt source PU specifies the interrupt destination process ID (PID) and generates a packet for interrupt notification (hereinafter referred to as the interrupt notification packet). All PUs 10 to 14 can get to know the process executed by the system by accessing the PRCLIST 300 in the MEM. When the interrupt source PU transmits the interrupt notification packet to the INTNW 2, the INTCTL 20 analyzes the packet, references the IDTBL 22 in accordance with the specified PID, determines the interrupt notification destination PU, and performs packet network path setup in relation to the interrupt issuance source PU and interrupt destination PU. When the PFUs 50, 51 send an interrupt notification to the PUs 10 to 14, the associated interrupt notification packet contains an issuance source PFU number. The INTCTL 20 analyzes the interrupt notification packet, references the IDTBL 22 in accordance with the PFU number to determine the interrupt notification destination PU, and performs packet network path setup in relation to the interrupt issuance source PFU and interrupt destination PU.

Since the INTNW 2 defines the relationship between the PIDs and PUs or the relationship between the PFUs and PUs as described above, the PUs do not have to keep track of a PU that performs the interrupt notification destination process. Therefore, an interrupt notification can be rapidly sent.

[Data Structure Handled by the Multiprocessor System]

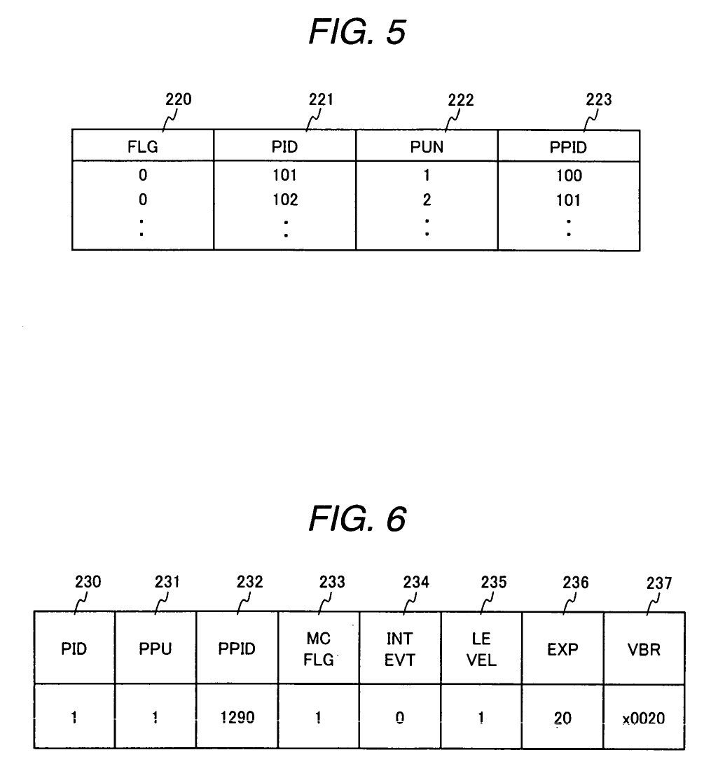

The data structure handled by the multiprocessor system according to the present invention will now be described with reference to FIGS. 5 and 6.

FIG. 5 shows an example of a process-to-processor unit correspondence management table.

FIG. 6 shows an example of an interrupt notification packet.

The IDTBL 22 is a table that manages the PUD-to-PU correspondence information and PFU-to-PU correspondence information.

A flag (FLG) 220 in the first field indicates whether the PID in the second field represents an interrupt notification destination process ID or interrupt notification source PFU number. In a PID 221 in the second field, either the interrupt notification destination process ID or interrupt generation source PFU number is stored in accordance with the flag in the first field.

In a PUN 222 in the third field, an interrupt notification destination PU number is stored. When the PID in the second field represents an interrupt notification destination process ID, the third field shows the number of a PU that performs the process indicated by the process ID. When, on the other hand, the PID in the second field represents an interrupt generation source PFU number, the third field shows an interrupt notification destination PU number that is associated with the interrupt generation source PFU.

A PPID 223 in the fourth field stores the PID of an interrupt notification source process that issued an interrupt for inter-PU interrupt notification.

The IDTBL 22 manages the interrupt notification source process PID and interrupt notification destination process PID as described above. It is therefore possible to exercise interrupt control over a plurality of processes by handling them as a process group.

If, for instance, it is assumed that a process group has a parent-to-child process relationship, which is generated by a parent process, the process ID of the parent process is stored in the fourth field (PPID) 223, whereas the process ID of a child that is generated by the parent process is stored in the second field (PID). Further, when the process of the child generates a grandchild process, the process ID of the child process is stored in the fourth field (PPID) 223, whereas the process ID of the grandchild process is stored in the second field (PID). In the example shown in FIG. 5, the process ID of a parent process is 100, the process ID of a child process of the parent process is 101, and the process ID of a grandchild process is 102.

When processes belonging to a process group are to be stopped, the IDTBL 22 is used to search for lower-level processes of the processes to be stopped, such as a child process issued by the parent process and a grandchild process issued by the child process. The INTNW can then multicast an interrupt notification to simultaneously stop the processes that belong to the process group.

For example, it is assumed that the process (PRC-A) 302 for PU1 11, which is shown in FIG. 4, is an image recognition process started by PU0 10. In other words, it is assumed that PRC-A 302 has started a process (PRC-B) 303 for performing image preprocessing such as characteristic point extraction for image recognition on PU2 12. More specifically, it is assumed that PU1 and PU2 coordinate (PRCGRP) to perform a process for intended image recognition. It is then assumed that an image recognition operation is aborted by PU0 10, and that an event occurs for switching to voice recognition. PU0 issues an interrupt packet for stopping the image process (PRC-A) 302 of PU1 11. However, PRC-A manages PRC-B 303 as a child process. Therefore, it is necessary to stop both PRC-A and PRC-B. As described above, the IDTBL 22 is managed so that PRC-B is a child process of PRC-A (for correspondence between the interrupt source process ID and interrupt destination process ID). Therefore, the INTNW 2 multicasts the interrupt packet issued by PU0 10 to PU1 11 and PU2 12. Consequently, a process stop process is performed at both PU1 and PU2. As a result, PU1 and PU2 can immediately switch to another process.

A method for updating entry information in the IDTBL 22 will now be described.

The IDTBL 22 references information from the PBUS 4. The PUs 10 to 14 accesses entries in the IDTBL via the DBUS 3, BRG 7, and PBUS 4 to set various field values.

The IDTBL 22 is updated in accordance with the process status or when the correspondence between the I/O devices and interrupt destinations is determined.

For example, the master PU (PU0), which starts up at system bootup, sets the default interrupt notification destination PU for the I/O devices 50, 51. The master PU can preset the interrupt network path in relation to the other PUs (PU1 to PU4) for the purpose of initializing them. Further, when all attempt is made after system startup, for instance, to generate a new process in a PU, stop or abort a process currently executed in a PU, or change the I/O interrupt notification destination PU, the PU accesses an entry within the IDTBL via the DBUS, BRG, and PBUS, and rewrites a register value in accordance with FIG. 4. The correspondence information (entry information) retained by the IDTBL 22 is such that one entry is basically provided for each PU. Therefore, the entry count, which represents the size of the IDTBL, is equal to the number of PUs.

In the above description, it is assumed that only one process is performed by each PU. However, a single PU can simultaneously perform two or more processes in a time-division multiplex manner. In such an instance, the PU performs a process for exercising process (task) management. At the time of a task changeover, the task management process accesses the IDTBL 22 and updates the PID 221 corresponding to the number of the PU to a newly selected process ID. As a result, the other PUs can access the above PU by specifying the updated PID. All the PIDs executed by the above PU are conveyed to the PRCLST 300, which the OS manages within a particular memory.

The format of the interrupt notification packet, which is created at the time of interrupt notification, will now be described.

As the PID 230 in the first field, the interrupt notification destination process ID or interrupt notification destination PU number is specified. When the process ID is specified as the PID 230, the INTNW converts the specified process ID to the number of the interrupt notification destination PU that performs the process specified by the process ID.

The PPU 231 in the second field is used to specify the interrupt issuance source PU number is specified. When an interrupt is issued by a PFU, however, the interrupt issuance source PFU number is specified instead of the interrupt issuance source PU number. The PPID 232 in the third field is used to specify the interrupt issuance source process ID for inter-PU notification. The MCFLG 233 in the fourth field is used to specify whether a unicast interrupt notification is to be sent to a single PU or a multicast interrupt notification is to be sent to a plurality of PUs that perform the process specified by the PID 230 in the first field and the lower-level processes subordinate to that process.

A broadcast interrupt notification, which sends an interrupt notification to all PUs, can also be specified by the fourth field. In this instance, the PID 230 in the first field is ignored. The INTEVT 234 in the fifth field is used to specify the interrupt factor code corresponding to an interrupt event. The LEVEL 235 in the sixth field is used to set an interrupt priority level. If, for instance, a plurality of interrupts exist for a single PU, interrupt packets are sequentially sent to the PU in order from the highest priority level to the lowest. The EXP 236 in the seventh field is used to specify the time for completing the interrupt notification, that is, the deadline for interrupt notification. The EXP value is set for interrupt processes that must be performed in real time. To ensure that the interrupt notification is completed before the deadline, priority is given to interrupt packets that need to be transmitted early to meet the deadline. As regards the priority, the EXP value is considered first. When there are certain time allowance or the same time allowance, the LEVEL 235 in the sixth field is used for priority level judgment. The VBR 237 in the eighth field is used to specify the first address of a memory that stores a program for the interrupt process to be started by the interrupt notification destination PU.

[Detailed Configuration and Operation of the Interrupt Notification Network]

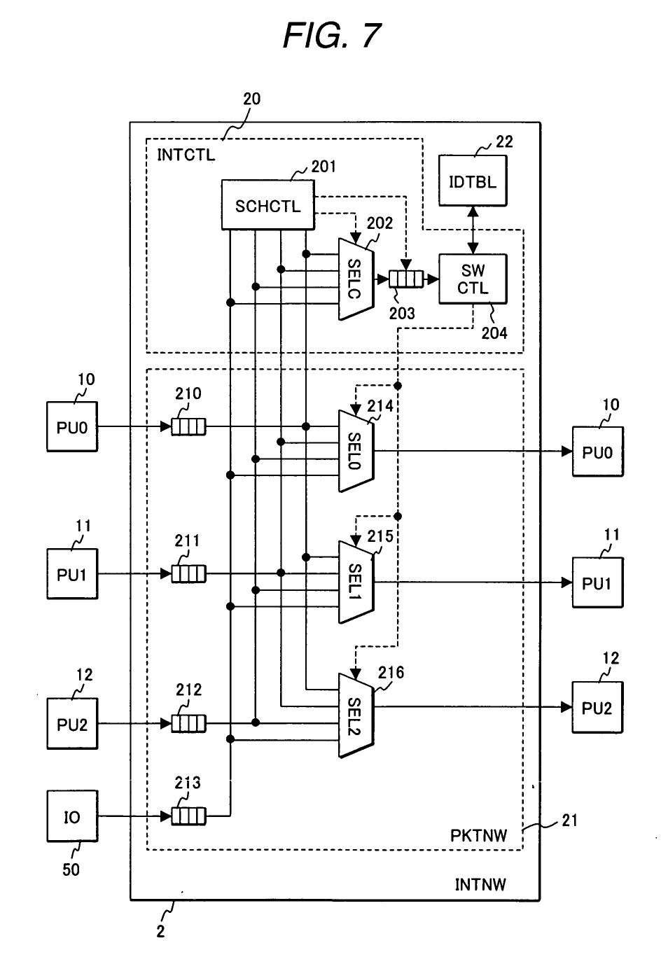

The detailed configuration and operation of the interrupt notification network will now be described with reference to FIG. 7.

FIG. 7 is a circuit diagram illustrating the interrupt notification network. Within the configuration shown in this figure, two PUs 10 to 12 and one I/O device 50 are connected to input ports of the INTNW, whereas three PUs 10 to 12 are connected to output ports. A crossbar network structure is formed in this manner to exercise packet control.

I/O device-to-PU interruption occurs in one direction only (from an I/O device to a PU). As described earlier, the INTNW 2 comprises the packet network (PKTNW) 21 and the interrupt controller (INTCTL) 20, which performs packet network path setup and arbitration. The PKTNW employs a crossbar network structure, and has priority queues 210 to 213 on the input port side and selectors (SEL0, SEL1, and SEL2) 214 to 216 on the output port side. The number of selectors is equal to the number of output ports. These selectors are controlled by a switch control circuit (SWCTL) 205, which is owned by the INTCTL 20, to connect one of the input ports owned by the INTNW 2 to the output ports of the INTNW 2.

The sizes of the queues 210 to 213 may vary with the size of a system's interrupt transaction.

The INTCTL 20 comprises a packet scheduler (SCHCTL) 201, a selector (SELC) 202, a priority queue 203, and a switch control circuit (SWCTL) 204. The SCHCTL 201 performs interrupt packet scheduling and arbitration by analyzing input packets and determining their levels and time limits. If, for instance, interrupt requests are simultaneously qenerated for a plurality of input ports, the SCHCTL 201 determines packets having a high priority. The SELC 202 selects an input port to which the packets are issued. The packets are then sequentially placed on the priority queue 203. If a plurality of packets are placed on the priority queue 203 and subsequent packets have a high priority, the subsequent packets are placed on the priority queue 203 by priority. As explained earlier, high-priority packets have a high priority level or need to be handled early to meet the interrupt notification deadline. Packets output from the priority queue 203 are forwarded to the SWCTL 204. The SWCTL analyzes the packets, references the IDTBL 22 in accordance with the interrupt issuance source process ID 230 or issuance source PFU number in the packets, and searches the IDTBL for the interrupt notification destination PU number 222. In accordance with the issuance source PU number or PFU number 231 and the issuance destination PU number 222, the SWCTL 204 controls the SELs 214 to 216 within the PKTNW to establish a packet path to the interrupt destination PU. When the multicast flag (MCFLG) 233 in the packet is set for a multiple interrupt multicast mode with the range specified, the SWCTL receives a plurality of interrupt notification destination PU numbers 222 from the IDTBL 22 and establishes a packet path to a plurality of PUs accordingly. It is assumed that the present embodiment includes one priority queue 203 and one SWCTL 204. To simultaneously process a plurality of packets, however, an alternative is to use a plurality of priority queues and SWCTLs, the number of which is equal to the number of output ports, conduct an IDTBL search, control the PKTNW selectors 214 to 216, and simultaneously establish a plurality of packet paths.

[Interrupt Notification Operation Performed by the Interrupt Notification Network]

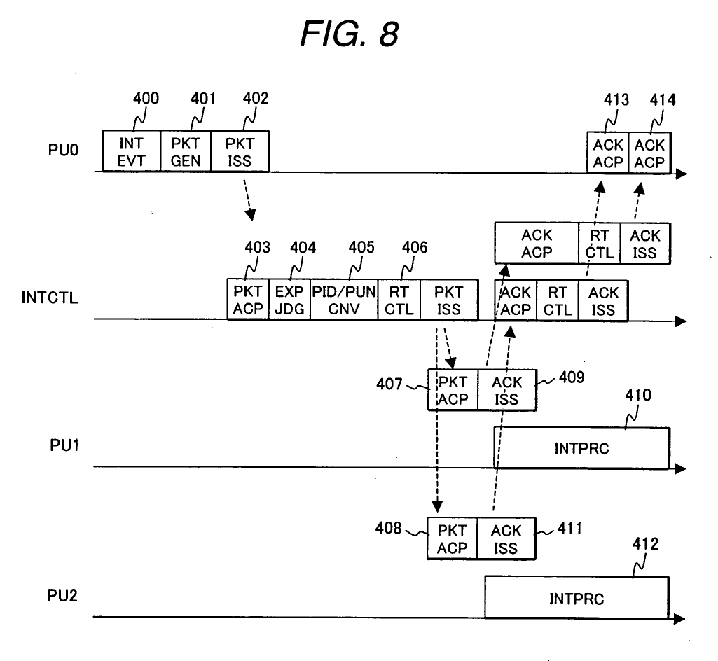

The interrupt notification operation performed by the multiprocessor system according to the present invention will now be described with reference to FIGS. 8 to 10.

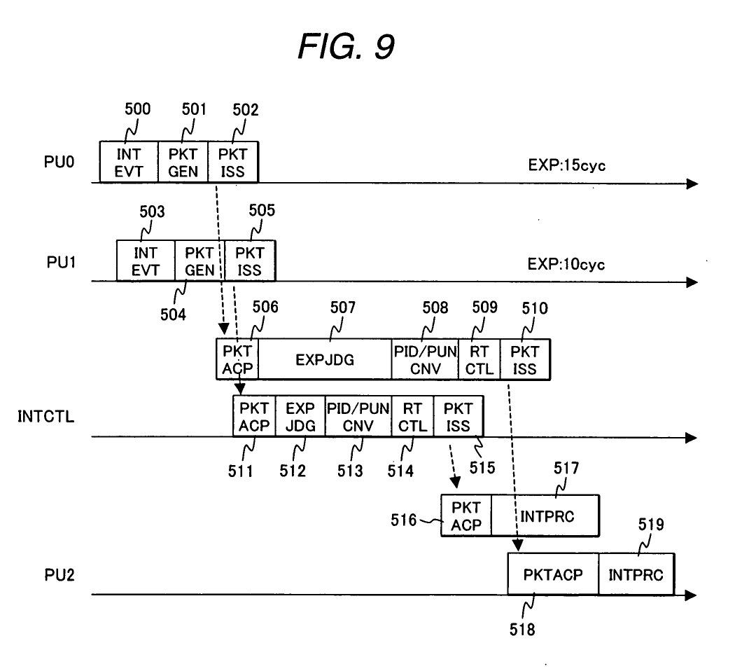

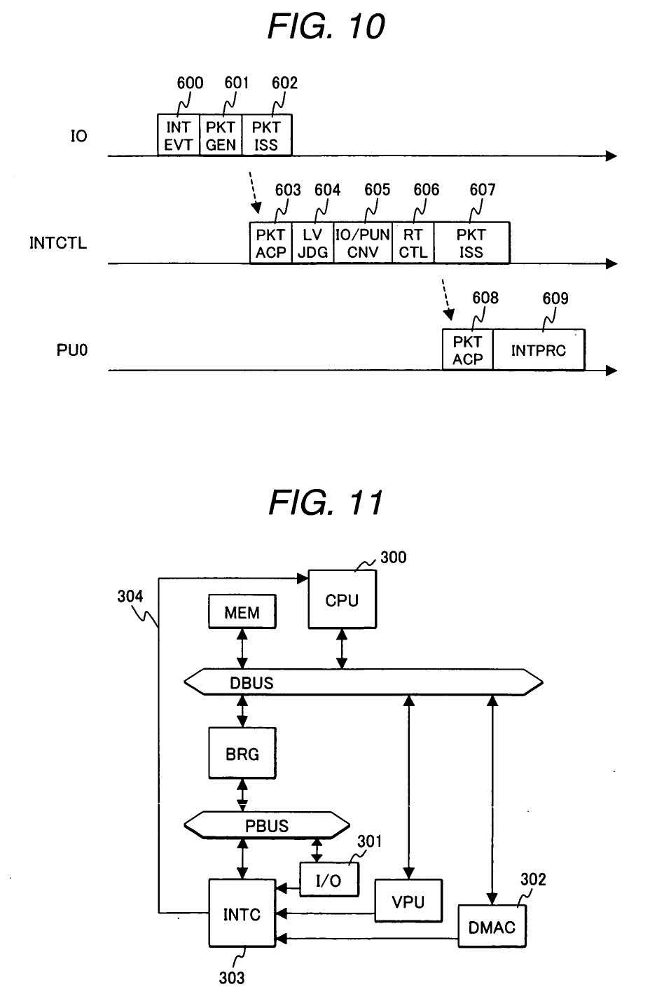

FIGS. 8 and 9 are timing diagrams illustrating an interrupt notification from one PU to another. FIG. 10 is a timing diagram illustrating an interrupt notification from an I/O device to a PU.

First of all, an interrupt multicast notification that is sent from PU0 10 to PU1 11 and PU2 12 during an inter-PU interrupt notification process will be described with reference to FIG. 8. It is assumed that a process is performed to generate an interrupt factor in PU0 10, and that a process is performed to send an interrupt notification to PU1 11, and further that a child process generated by a PU1 process is performed in PU2 12 to interrupt both the PU1 process and PU2 process. This operation may be performed, for instance, to simultaneously stop processes.

When an interrupt factor is generated (INTEVT) in PU0 10, which is an issuance source (400), PU0 generates an interrupt packet (PKTGEN) in accordance with the packet format shown in FIG. 6 (401), and issues the interrupt packet (PKTPSS) to the INTNW 2 (402). The issued interrupt packet is temporarily stored on the priority queue 210 within the INTNW shown in FIG. 7. If a plurality of packets are already queued, the packets are queued in order from the highest priority to the lowest. The queue 210, on which the packet is stored, outputs the packet. The SCHCTL 201 receives the output packet (PKTACP) (403), analyzes the packet, judges its priority (EXPJDG) in accordance with the level (LEVEL) 235 and deadline (EXP) 236 (404), and places the packet on the priority queue 203 within the INTCTL. The received packet is then forwarded to the SWCTL 204. The SWCTL 204 accesses the IDTBL 22 in accordance with packet information, determines the PU number of the packet transmission destination from the PID information 230 within the packet (PID/PUNCNV) (405), and exercises selector control of the PKTNW 21.

The present embodiment assumes that the MCFLAG 233 in the packet is set to use the multicast notification mode. In this instance, the IDTBL outputs the PU number (PU1 11) corresponding to the interrupt notification destination PID 230 and the PU number of an entry whose process PID 230 coincides with the PPID 223 in the IDTBL 22, that is, the PU number (PU2) for performing a child process of the process performed by PU1.

The SWCTL 204 then controls SELL 215 and SEL2 216 of the PKTNW to create a PU0-to-PU1 packet path and PU0-to-PU2 packet path (RTCTL) (406). As a result, the interrupt packet from PU0 is received by both PU1 11 and PU2 12 (PKTACP) (407, 408). PU1 and PU2 load a program from the first address of the interrupt process program specified in the packet (VBR 237) and initiate an interrupt process (INTPRC) (410, 412). Alternatively, an operation may be performed simply to communicate the interrupt factor (INTEVT 234) to the associated process without starting the interrupt process program. For example, an alternative is to write the INTEVT 234 in the interrupt event register owned by a PU, thereby allowing the process to poll the interrupt event register for the purpose of receiving an interrupt notification. Upon receipt of the packet, PU1 and PU2 use the issuance source PU number (PPID 232) in the packet to generate a packet (ACK) for informing the issuance source PU (PU0 10) that the interrupt notification is received (ACKISS) (409, 411), and send the generated packet to PU0, which is the interrupt source, via the INTNW (413, 414).

Next, the operation performed to let a plurality of PUs send interrupt notifications to a single PU virtually simultaneously during an inter-PU interrupt notification process will be described with reference to FIG. 9. It is assumed that PU0 10 and PU1 11 issue interrupts to PU2 12 virtually simultaneously, and that the levels (LEVEL 235) of the interrupts issued by the PUs are the same. However, it is assumed that the time remaining before the interrupt notification deadline for PU1 is shorter than the time remaining before the interrupt notification deadline for PU0. It means, for example, that the interrupt notification deadline (EXP 236) for PU0 is 15 cycles while the interrupt notification deadline for PU1 is 10 cycles. In other words, it is assumed that the interrupt request of PU1 should be processed prior to that of PU0.

When interrupt factors are generated virtually simultaneously in PU0 and PU1 (INTEVT) (500, 503), the PUs generate interrupt packets containing the interrupt destination process IDs (which are the same in the currently used example) (PKTGEN) (501, 504), and issue the generated packets to the INTNW 2 (PKTISS) (502, 505). The packets are temporarily stored on the priority queues 210, 211 within the INTNW, which correspond to the issuance source PUs. The queues then output the packets. The SCHCTL 204 within the INTCTL 20 receives the packets (PKTACP) (506, 511), which were issued by PU0 10 and PU1 11. The INTCTL 20 analyzes the packets, judges the priority in accordance with the level (LEVEL 235) and deadline (EXP 236) (EXPJDG) (507, 512), and stores the packets on a queue in the INTCTL. The interrupt levels (LEVELS) of the packets are the same. However, the interrupt notification deadline value is 15 for PU0 and 10 for PU1. It means that the interrupt packet issued by PU1 has a relatively high priority. PU1's packet is forwarded to the SWCTL prior to PU0's packet. The SWCTL 204 accesses the IDTBL 22 in accordance with the packet information to determine the packet destination PU number from the PID information in the packet (PID/PUNCNV) (513), and controls the selector (SEL2) in the PKTNW 21 (RTCTL) (514). Subsequently, PU0's packet is also forwarded to the SWCTL 201. The SWCTL 201 controls the selector (SEL2) in the PKTNW 21 (509). As a result, PU2 receives the packet issued by PU1 prior to the packet issued by PU0 (PKTACP) (516), analyzes the received packet, and begins to perform an interrupt process (INTPRC) (517). After receipt of the packet issued by PU1, PU2 receives the packet issued by PU0 (PKTACP) (518) and analyzes the received packet. After termination of the preceding interrupt process, PU2 performs an interrupt process on the packet issued by PU0 (INTPRC) (519).

The interrupt notification process that the PFU (I/O device) 50 performs in relation to PU0 10 will now be described with reference to FIG. 10.

When an interrupt factor is generated in the I/O device 50 (INTEVT) (600), the I/O device 50 generates an interrupt notification packet (PKTGEN) (601), which contains the local I/O number 231, interrupt level (LEVEL) 235, and interrupt factor (INTEVT) 234, and issues the generated packet to the INTNW 2 (PKTISS) (602). The packet is temporarily stored on the priority queue 213 within the INTNW 2. The SCHCTL 201 within the INTCTL 20 receives the packet (PKTACP) (603). The SCHCTL 201 analyzes the received packet, judges the priority in accordance with the interrupt level and deadline (LVJDG) (604), and stores the packet on the priority queue 203. Next, the SWCTL 204 accesses the IDTBL 22, determines the interrupt notification destination PU number from the issuance source I/O number in the packet (IO/PUNCNV) (605), and controls the selector (SEL0) 214 in the PKTNW 21 (RTCTL) (606). As a result, the packet path for a packet transmission from the I/O device to the PU0 is established. PU0 then receives an interrupt packet from the I/O device (PKTACP) (608), jumps to the interrupt process program address (VBR) 237, and performs an interrupt process (INTPRC) (609).

[Present Invention's Features Revealed by the Description of the Embodiments]

As is obvious from the foregoing description of the embodiments, the present invention offers, particularly in a multiprocessor system in which many PUs are installed, means for efficiently communicating an interrupt notification between PUs or between an I/O device and PU. Thus, the present invention performs an inter-PU multiplex coordination process for inter-PU process synchronization and process control, and increases the system throughput of the multiprocessor system. The present invention also provides a multiprocessor system that is capable of performing real-time processing in relation to various external factors, for instance, by immediately responding to an emergency.

What is claimed is:

1. A multiprocessor system that contains a plurality of processors to send an interrupt notification from one processor to another, the multiprocessor system comprising:
an interrupt notification network that is connected to the plurality of processors to send an interrupt notification packet from an interrupt notification source processor to an interrupt notification destination processor,
wherein the interrupt notification network includes a control section; and
wherein the control section analyzes the interrupt notification packet transmitted from the interrupt notification source processor and determines the interrupt notification destination processor.

2. The multiprocessor system according to claim 1, wherein the interrupt notification network retains the information for determining the interrupt notification destination processor.

3. The multiprocessor system according to claim 1, wherein the interrupt notification packet contains an interrupt destination process ID; and wherein the control section references the Interrupt destination process ID to determine the interrupt notification destination processor.

4. The multiprocessor system according to claim 1, wherein the control section handles a processor performing a plurality of processes belonging to a process group as an interrupt notification destination processor.

5. The multiprocessor system according to claim 4, wherein an interrupt multicast notification is sent to a processor performing a process belonging to a process group.

6. The multiprocessor system according to claim 4, wherein an interrupt multicast notification is sent to all processors connected to the interrupt notification network.

7. The multiprocessor system according to claim 1, wherein the interrupt notification packet contains the information indicating an interrupt level or the degree of emergency; and wherein the control section determines the priority of an interrupt notification in accordance with the information indicating an interrupt level or the degree of emergency.

8. The multiprocessor system according to claim 1, wherein the interrupt notification network has a crossbar network structure.

9. A multiprocessor system that contains a plurality of processors to send an interrupt notification from an input/output device to a processor, the multiprocessor system comprising:
an interrupt notification network that is connected to the plurality of processors to send an interrupt notification packet from an interrupt notification source input/output device to an interrupt notification destination processor,
wherein the interrupt notification network includes a control section; and
wherein the control section analyzes the interrupt notification packet transmitted from the interrupt notification source input/output device and determines the interrupt notification destination processor.

10. The multiprocessor system according to claim 9, wherein the interrupt notification packet contains an interrupt source input/output device number; and wherein the control section references the interrupt source input/output device number to determine the interrupt notification destination processor.
